(19) United States
(12) Patent Application Publication
(10) Pub. No.: US 2016/0041407 A1
(43) Pub. Date: Feb. 11, 2016

(54) COLOR IMAGE PATCH FOR CONTACT LENS

(71) Applicant: OPENVISION CORPORATION, Taoyuan County (TW)

(72) Inventors: Ming Yi CHOU, Taoyuan County (TW); Fong Chen CHOU, Taoyuan County (TW); Ta Jen HSING, Taipei (TW); Takahiro TAKAHASHI, Taoyuan County (TW)

(73) Assignee: OPENVISION CORPORATION, Taoyuan County (TW)

(21) Appl. No.: 14/456,499

(22) Filed: Aug. 11, 2014

(51) Int. Cl. G02C 7/04; G02B 1/14; G02C 11/02

(52) U.S. Cl. CPC G02C 7/046; G02C 11/02; G02B 1/14; G02C 2202/16

(57) ABSTRACT

A color image patch for use with contact lens includes an attachment layer having one side for adsorbing to a surface of a contact lens, and an image layer connected to another side of the attachment layer and having an ornamental design provided thereon. Before wearing the contact lens, a wearer first selects a color image patch with favorite ornamental design and then attaches the attachment layer of the color image patch to the surface of the contact lens. The ornamental design on the image layer of the color image patch being adsorbed to the contact lens is located at a position corresponding to a wearer's iris and capable of changing the shape, size and color of the wearer's iris without influencing the vision correction function of the contact lens. Therefore, the color image patch gives the contact lens additional function and increased usefulness.

### FIELD OF THE INVENTION

The present invention relates to a patch, and more particularly, to a color image patch that can adsorb to the surface of a contact lens to beautify a wearer's eye without adversely influencing the vision correction function of the contact lens, so as to increase the added value of the contact lens.

### BACKGROUND OF THE INVENTION

Contact lenses are lenses placed directly on the surface of corneas to correct vision or protect eyes. Contact lenses do not include a heavy frame and thick lenses, but have a small volume and are conveniently portable. Since contact lenses do not add burden to eyes and would not affect the wearer's face and appearance, they have been widely adopted by people since they were introduced into the market. Particularly, young men and women who care about their looks all select contact lenses to correct their vision.

As a consequence of mature contact lens technique and people's new demands for eyewear, color contact lenses are now used not only for vision correction, but also for cosmetic or decorative purpose, such as changing the wearer's eye color and making the eyes look bigger. The currently commercially color contact lenses include a color pattern embedded in the lenses. When a wearer wants to change the color pattern of the color contact lenses, he or she has to purchase another pair of color contact lenses of different color pattern for wearing. It is obviously inconvenient for the wearer to do so.

Further, the conventional color contact lenses that provide both functions of correcting vision and making pupils look bigger are usually much expensive than general contact lenses. However, the high price would inevitably lower the wearers' intention to use the multi-functional color contact lenses.

While there are many different brands of color contact lenses available in the market, not all of them well suit a particular wearer. Wearers would usually carefully select a certain favorite brand of color contact lenses that are comfortable for wearing. Another problem is that the color contact lenses of a favorite brand and comfortable for wearing might not present the wearer's favorite color pattern. That is, it is not easy for the conventional color contact lenses to satisfy the wearer's requirements for comfortable wearing and favorite color pattern at the same time.

In view of the disadvantages of the conventional color contact lenses in use, it is tried by the inventor to develop a color image patch that can be adsorbed to a contact lens to change the color, pattern, shape and size of the wearer's iris without influencing the vision correction function of the contact lens.

### SUMMARY OF THE INVENTION

A primary object of the present invention is to provide a color image patch that can adsorb to the surface of a contact lens to provide the effect of changing the shape, size, color and pattern of a wearer's iris without adversely influencing the vision correction function of the contact lens, and therefore increases the added value of the contact lens.

Another object of the present invention is to provide a color image patch that can have an annular configuration with a hollow central area, so that a contact lens with the color image patch adsorbed thereto can maintain best light transmittance at an area corresponding to a wearer's pupil.

A further object of the present invention is to provide a color image patch that can include a protection layer to prevent pigments on the color image patch from directly contacting with a wearer's cornea when the color image patch is attached to a concave surface of a contact lens, so that the contact lens is safer and more comfortable for wearing.

To achieve the above and other objects, the color image patch provided according to a preferred embodiment of the present invention for use with a contact lens includes an attachment layer, which is adsorbed to a surface of the contact lens and provided with a first opening; an image layer, which is connected to one side of the attachment layer and is provided with a second opening and an ornamental design, so that the attachment layer is located between the image layer and the contact lens and the first and second openings together define a through hole on the color image patch; and a protection layer, which is connected to one side of the image layer opposite to the attachment layer, so that the image layer is sandwiched between the attachment layer and the protection layer.

When the contact lens having the color image patch attached thereto is in use, the ornamental design on the image layer is located corresponding to a wearer's iris and the through hole of the color image patch is located corresponding to the wearer's pupil. According to the preferred embodiment of the present invention, the attachment layer is adsorbed to the surface of the contact lens through intermolecular force acting between the attachment layer and the contact lens, and the intermolecular force can be a chemical bond or a physical bond.

The chemical bond can be any one of a metallic bonding, an ionic bonding and a covalent bonding; and the physical bond can be any one of a hydrogen bond and a Van Der Waals bond. Further, the attachment layer is formed of a material the same as that of the contact lens.

The color image patch according to the present invention is characterized in that the attachment layer is adsorbed to the surface of the contact lens and the ornamental design on the image layer is annularly located corresponding to the wearer's iris, so that the ornamental design on the image layer can change the shape, size, color and pattern of the wearer's iris and makes the wearer's eye look bigger and beautiful.

In addition, since the color image patch of the present invention adsorbed to the contact lens does not adversely influence the vision correction function of the contact lens while the ornamental design on the image layer changes the color of the wearer's iris, it largely increases the added value and usefulness of the contact lens.

According to the present invention, since the image layer is located between the attachment layer and the protection layer, the colors and the pattern of the ornamental design can be fully presented without the risk of fading, and pigments on the ornamental design will not directly contact with the wearer's cornea, the contact lens having the color image patch adsorbed thereto is safe and comfortable for wearing.

Moreover, by providing the first and the second opening at the center of the attachment layer and of the image layer, respectively, to form the through hole on the color image patch corresponding to a wearer's pupil and give the patch an annular configuration, the contact lens with the color image patch adsorbed thereto can maintain best light transmittance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a color image patch for contact lens according to a first preferred embodiment of the present invention;

FIGS. 2A and 2B are exploded perspective view and assembled sectional view, respectively, showing a first way of attaching the color image patch of FIG. 1 to a contact lens;

FIGS. 3A and 3B are exploded perspective view and assembled sectional view, respectively, showing a second way of attaching the color image patch of FIG. 1 to a contact lens;

FIG. 4 is an exploded perspective view of a color image patch for contact lens according to a second preferred embodiment of the present invention;

FIGS. 5A and 5B are exploded perspective view and assembled sectional view, respectively, showing a first way of attaching the color image patch of FIG. 4 to a contact lens;

FIGS. 6A and 6B are exploded perspective view and assembled sectional view, respectively, showing a second way of attaching the color image patch of FIG. 4 to a contact lens;

FIG. 7 is an exploded perspective view of a color image patch for contact lens according to a third preferred embodiment of the present invention;

FIGS. 8A and 8B are exploded perspective view and assembled sectional view, respectively, showing a first way of attaching the color image patch of FIG. 7 to a contact lens;

FIGS. 9A and 9B are exploded perspective view and assembled sectional view, respectively, showing a second way of attaching the color image patch of FIG. 7 to a contact lens;

FIG. 10 is an exploded perspective view of a color image patch for contact lens according to a fourth preferred embodiment of the present invention;

FIGS. 11A and 11B are exploded perspective view and assembled sectional view, respectively, showing a first way of attaching the color image patch of FIG. 10 to a contact lens; and

FIGS. 12A and 12B are exploded perspective view and assembled sectional view, respectively, showing a second way of attaching the color image patch of FIG. 10 to a contact lens.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

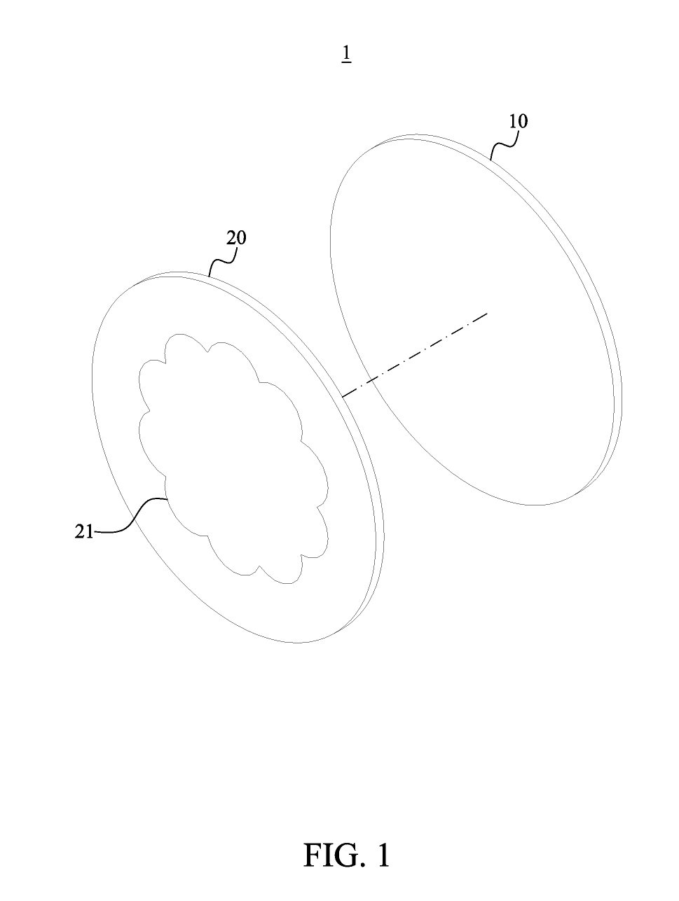

Please refer to FIG. 1 that is an exploded perspective view showing a color image patch for contact lens according to a first preferred embodiment of the present invention. For the purpose of conciseness and clarity, the present invention is also briefly referred to as the “color image patch” and generally denoted by reference numeral 1 herein. As shown, in the first preferred embodiment, the color image patch 1 includes an attachment layer 10 and an image layer 20 connected to one side of the attachment layer 10. The attachment layer 10 can include a hydrogel polymer material or a silicone hydrogel material, which is mixed with a resin, a cross-linking agent, an initiator, a bonding agent, a solvent, other additives or any combination thereof. In the illustrated first preferred embodiment, the hydrogel polymer material can be a polymer composed of hydrophilic 2-hydroxyethyl methacrylate, N-vinyl pyrrolidone and methacrylic acid; and the silicone hydrogel material can be a polymer composed of a silicone hydrogel monomer having high oxygen permeability and a polyvinylpyrrolidone material.

The image layer 20 has an ornamental design 21 provided thereon, and the ornamental design 21 can be formed with a type of pigment or multiple types of dyes.

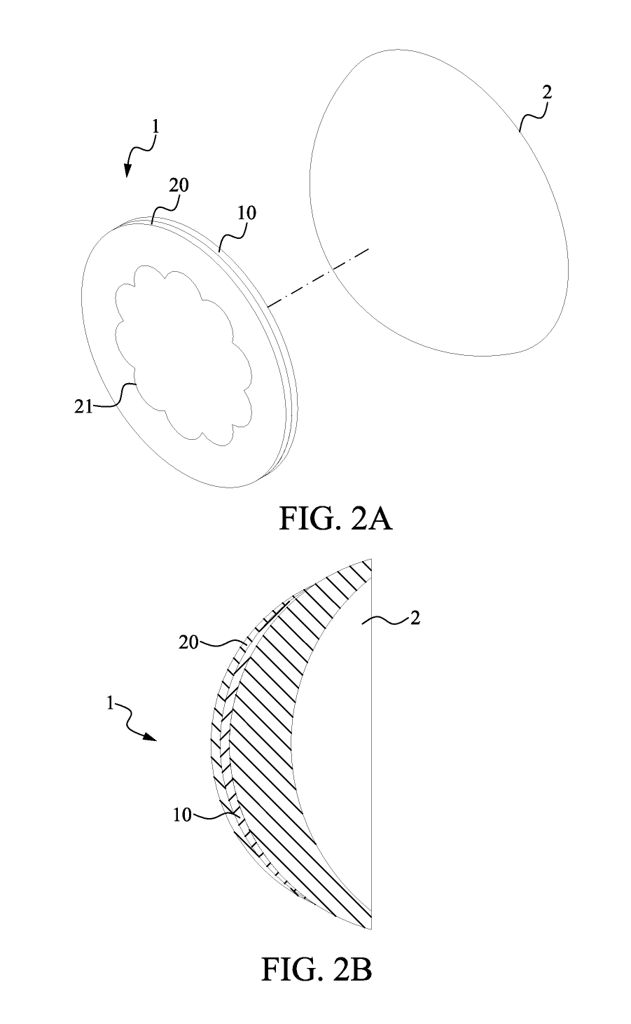

Please refer to FIGS. 2A and 2B. To use the color image patch 1 according to the first preferred embodiment, simply attach the attachment layer 10 of the color image patch 1 to the convex surface of a contact lens 2, so that the attachment layer 10 is located between the image layer 20 and the contact lens 2 and adsorbed to the contact lens 2. That is, when wearing the contact lens 2 having the color image patch 1 adsorbed to the convex surface thereof, the concave surface of the contact lens 2 is in contact with the wearer's cornea, and the ornamental design 21 on the image layer 20 is annularly located corresponding to the wearer's iris. With the ornamental design 21 provided on the image layer 20, it is able to change the shape, size, color and pattern of the wearer's iris, making the wearer's eye look bigger.

In the first preferred embodiment, both of the contact lens 2 and the attachment layer 10 of the color image patch 1 are made of hydrophilic materials. Further, the surface of the contact lens 2 and the side of the attachment layer 10 that is adsorbed to the contact lens 2 all are of a reticular structure. Through the intermolecular force acting between the attachment layer 10 and the contact lens 2 and the interconnection of the two reticular structures, the attachment layer 10 is able to adsorb to the convex surface of the contact lens 2 without the risk of easily separating therefrom. However, it is understood the contact lens 2 and the attachment layer 10 made of hydrophilic materials are only illustrative and not intended to limit the present invention in any way. That is, so long as the contact lens 2 is made of a material the same as that of the attachment layer 10, the attachment layer 10 can firmly adsorb to the contact lens 2 through the intermolecular force acting between them.

In addition, the intermolecular force acting between the attachment layer 10 and the contact lens 2 can be a physical bond that has a relatively small energy or a chemical bond that has a relatively large energy. The physical bond can be a hydrogen bond, a Van Der Waals bond, or a combination thereof; and the chemical bond can be a metallic bonding, an ionic bonding, a covalent bonding or any combination thereof. According to the present invention, the color image patch 1 preferably has a thickness less than 0.04 mm, and most preferably less than 0.03 mm.

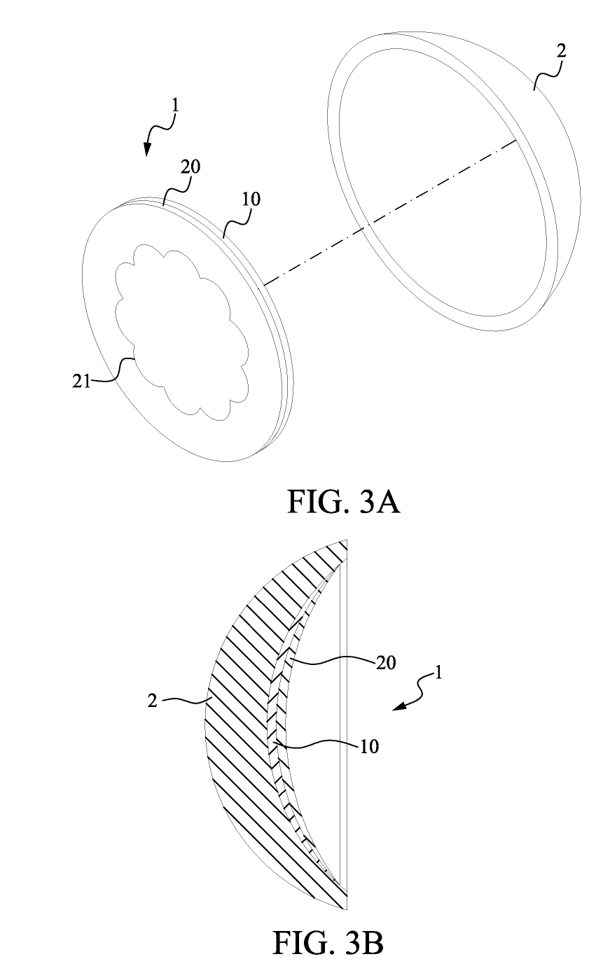

It is understood the adsorption of the color image patch 1 to the convex surface of the contact lens 2 is only illustrative and not intended to limit the present invention in any way. In another operable embodiment, as shown in FIGS. 3A and 3B, the color image patch 1 can also be adsorbed to the concave surface of the contact lens 2, so that the image layer 20 is in contact with a wearer's cornea when the contact lens 2 is in use.

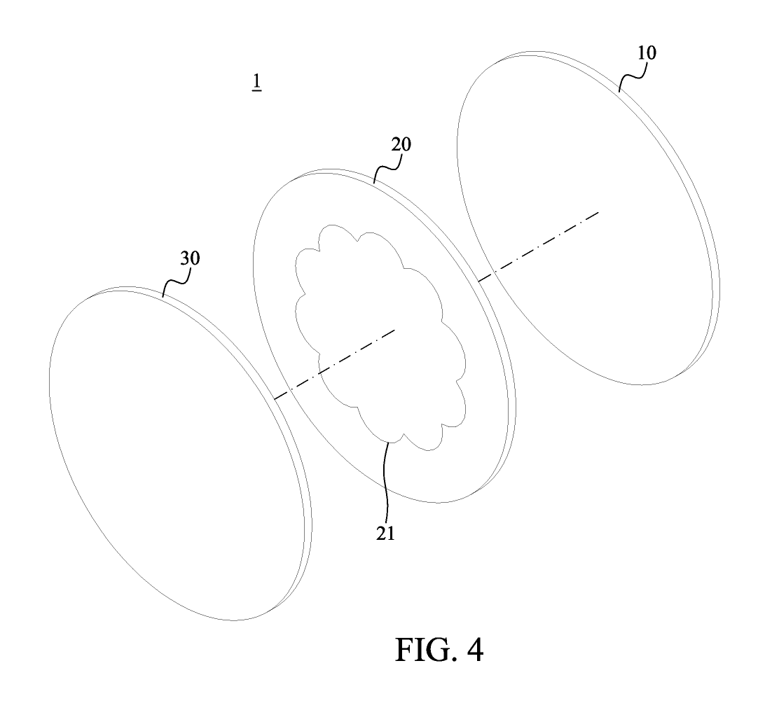

Please refer to FIG. 4 that is an exploded perspective view showing the color image patch 1 according to a second preferred embodiment of the present invention. As shown, the second preferred embodiment is different from the first one in further including a protection layer 30 connected to one side of the image layer 20 opposite to the attachment layer 10. Therefore, in the second preferred embodiment, the image layer 20 is located between the attachment layer 10 and the protection layer 30. With this arrangement, the ornamental design 21 on the image layer 20 can fully present its colors without the risk of fading easily. According to the present invention, the protection layer 30 is composed of a resin, a cross-linking agent, an initiator, a solvent and other additives or any combination thereof. Since the attachment layer 10 and the image layer 20 in the second preferred embodiment have structural configurations the same as those in the first preferred embodiment, they are not repeatedly described herein.

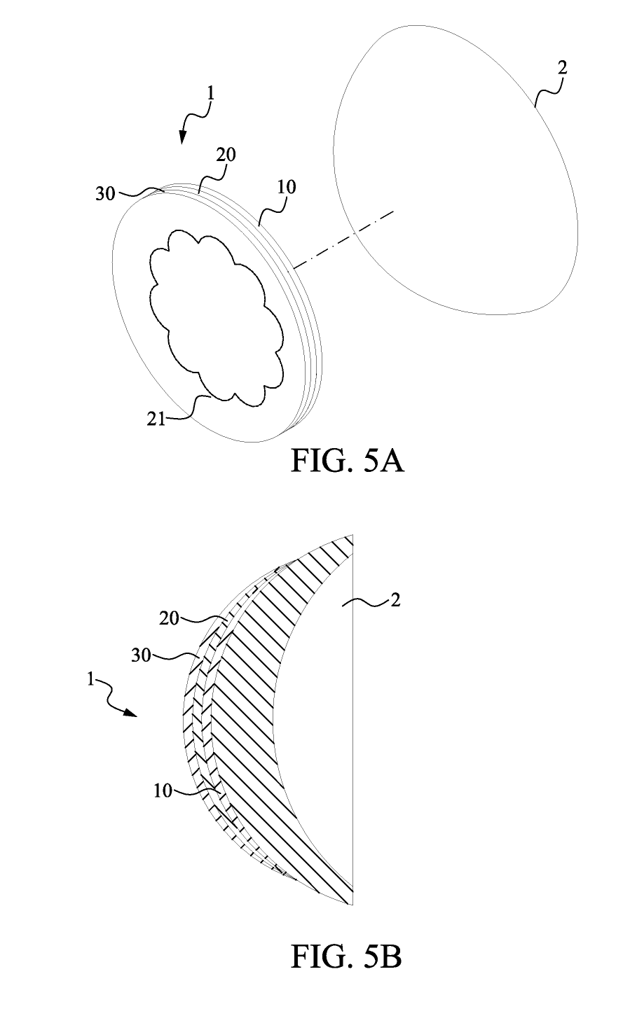

Please refer to FIGS. 5A and 5B. To use the color image patch 1 according to the second preferred embodiment, simply attach the color image patch 1 to the convex surface of the contact lens 2 as in the first preferred embodiment, so that the attachment layer 10 is adsorbed to the contact lens 2. With the protection layer 30, the wearer's fingers handling the contact lens 2 will not directly contact with the ornamental design 21 on the image layer 20, so that the chance of having a faded ornamental design 21 on the image layer is lowered and the service life of the color image patch 1 can be extended.

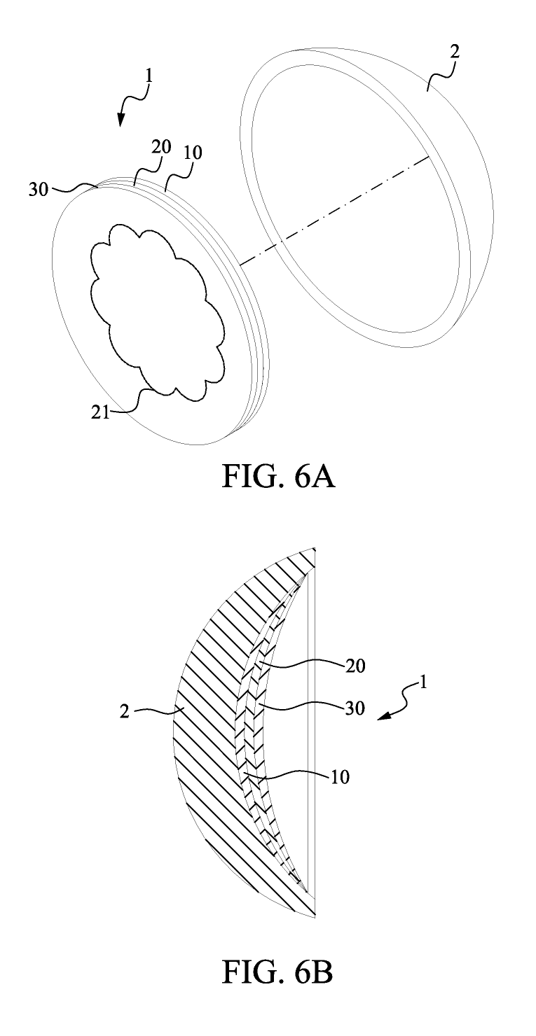

It is understood the adsorption of the color image patch 1 to the convex surface of the contact lens 2 is only illustrative and not intended to limit the present invention in any way. In another operable embodiment, as shown in FIGS. 6A and 6B, the color image patch 1 can also be adsorbed to the concave surface of the contact lens 2, so that the protection layer 30 is in contact with a wearer's cornea when the contact lens 2 is in use. With the protection layer 30, pigments of the ornamental design 21 on the image layer 20 will not directly contact with or fall on the wearer's cornea, so that the contact lens 2 with the color image patch 1 adsorbed thereto is more comfortable for wearing.

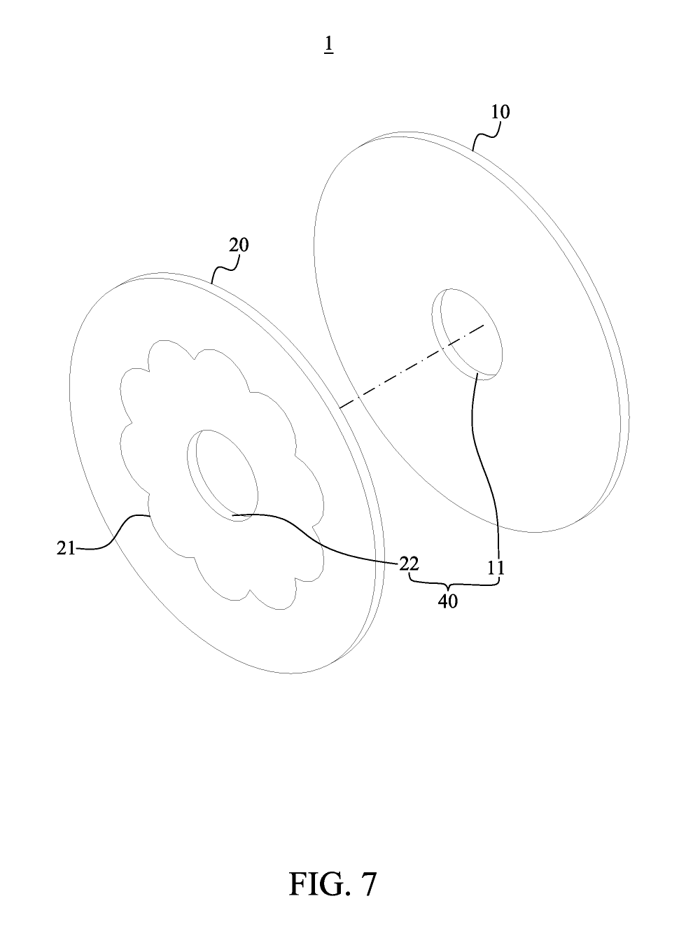

FIG. 7 is an exploded perspective view showing the color image patch 1 according to a third preferred embodiment of the present invention. As shown, the third preferred embodiment is different from the first one in further including a centered through hole 40, so that the color image patch 1 in the third preferred embodiment has an annular configuration with a hollow central area. As shown in FIG. 7, the attachment layer 10 has a first opening 11, and the image layer 20 has a second opening 22. The first opening 11 and the second opening 22 together define the through hole 40. Since all other structural features of the third preferred embodiment are similar to the first preferred embodiment, they are not repeatedly described herein.

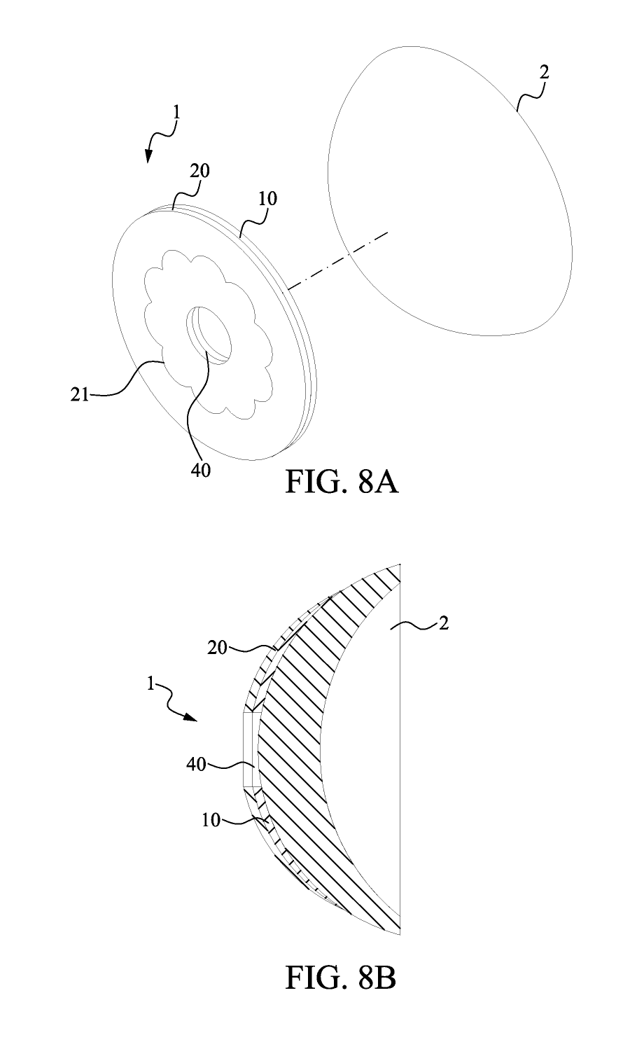

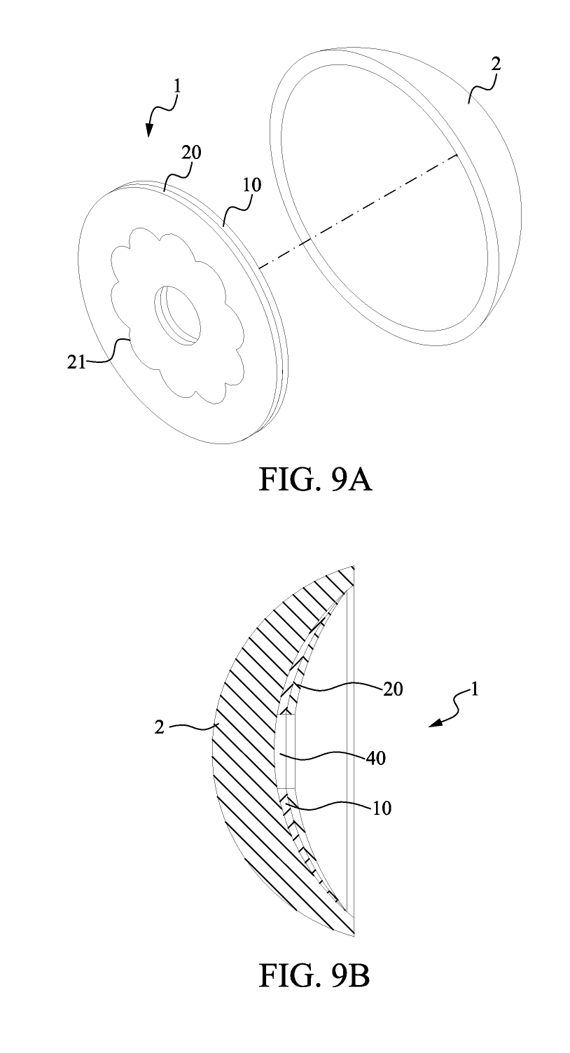

Please refer to FIGS. 8A and 8B as well as FIGS. 9A and 9B. When the attachment layer 10 of the color image patch 1 according to the third preferred embodiment is adsorbed to the convex surface or the concave surface of the contact lens 2, the through hole 40 of the color image patch 1 is located corresponding to the wearer's pupil (not shown). When the contact lens 2 with the color image patch 1 of the third embodiment adsorbed thereto is in use, the through hole 40 on the color image patch 1 allows the contact lens 2 to have best light transmittance, so that the wearer can see clearer without distortion.

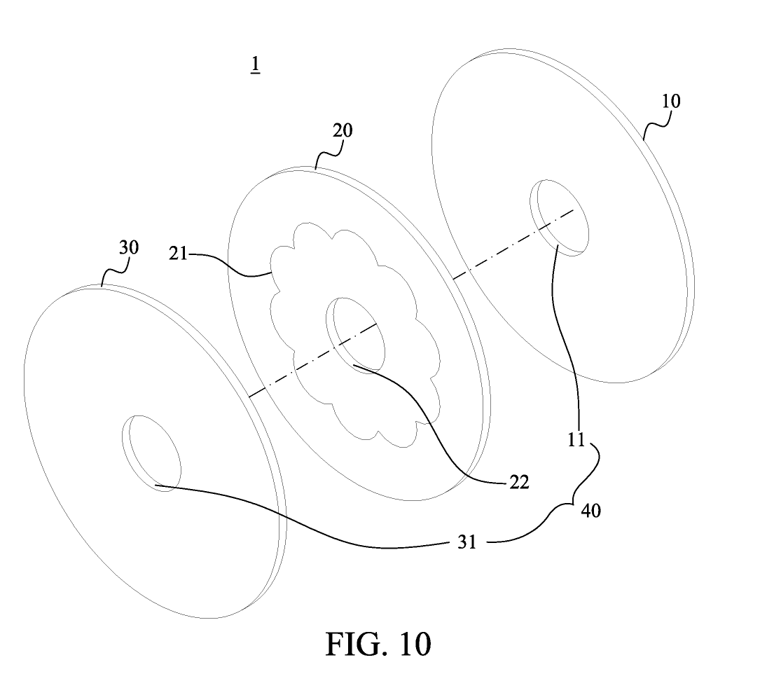

FIG. 10 is an exploded perspective view showing the color image patch 1 according to a fourth preferred embodiment of the present invention. As shown, the fourth preferred embodiment is different from the second one in further including a centered through hole 40. As shown in FIG. 10, the attachment layer 10 has a first opening 11, the image layer 20 has a second opening 22, and the protection layer 30 has a third opening 31. The first opening 11, the second opening 22 and the third opening 31 together define the through hole 40 on the color image patch 1. Since all other structural features of the fourth preferred embodiment are similar to the second preferred embodiment, they are not repeatedly described herein.

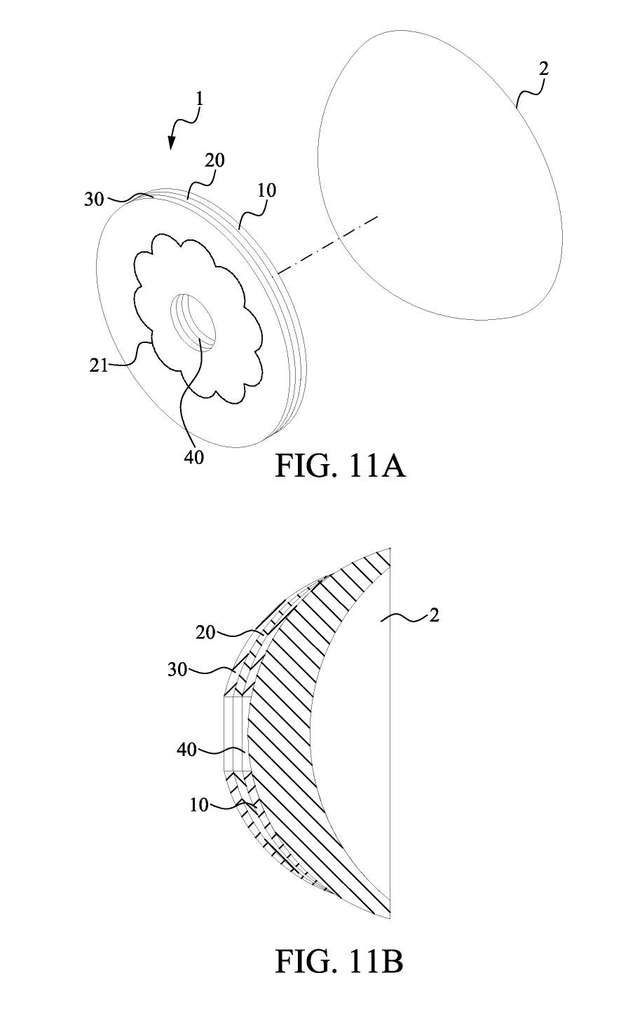

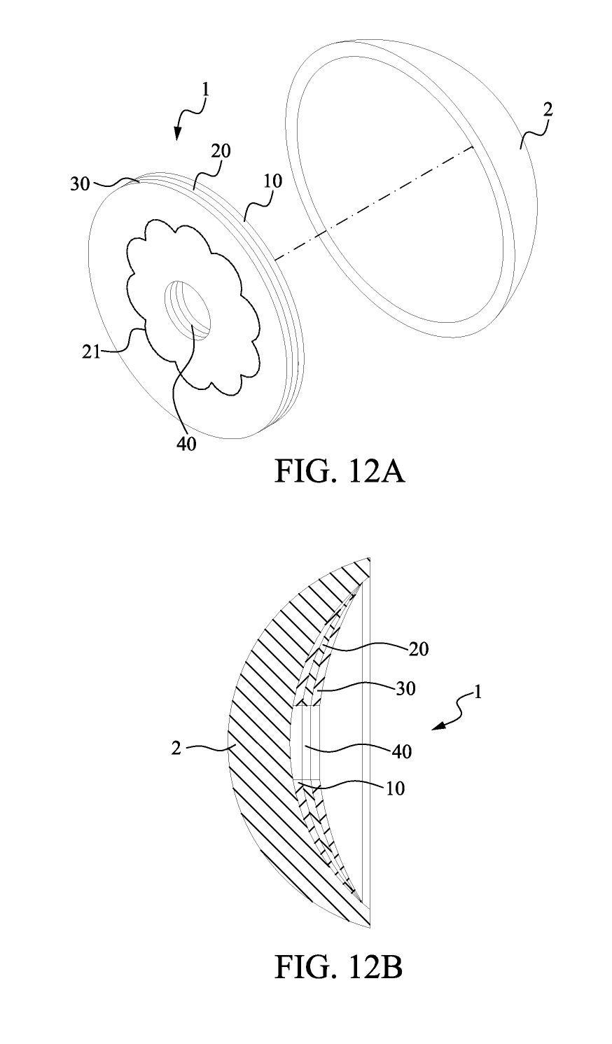

Please refer to FIGS. 11A and 11B as well as FIGS. 12A and 12B. Since the color image patch 1 according to the fourth preferred embodiment is used in a manner and provides functions the same as the third preferred embodiment, it is not repeatedly described herein.

In summary, the present invention provides a color image patch, which has an attachment layer for adsorbing to a surface of a contact lens, so that an ornamental design provided on an image layer of the color image patch is annularly located corresponding to a wearer's iris when the contact lens is in use. The ornamental design provided on the image layer changes the shape, size, color and pattern of the wearer's iris and makes the wearer's eye look bigger and beautiful.

The color image patch adsorbed to the surface of the contact lens can change the contact lens wearer's iris color without adversely influencing the vision correction function of the contact lens, and therefore increases the added value and the usefulness of the contact lens.

Further, by arranging the image layer between the attachment layer and the protection layer, the colors and pattern of the ornamental design on the image layer of the color image patch can be fully presented without the risk of fading, and the pigments of the ornamental design are not in direct contact with the wearer's cornea, making the contact lens with the color image patch adsorbed thereto safer and more comfortable for wearing.

Moreover, by providing the first and the second opening at the center of the attachment layer and of the image layer, respectively, a through hole is formed on the color image patch and gives the latter an annular configuration. When the contact lens with the color image patch adsorbed thereto is in use, the through hole of the color image patch is located corresponding to the wearer's pupil, allowing the contact lens to have best light transmittance, so that the wearer can see clearer without distortion.

The present invention has been described with some preferred embodiments thereof and it is understood that many changes and modifications in the described embodiments can be carried out without departing from the scope and the spirit of the invention that is intended to be limited only by the appended claims.

1. A color image patch, comprising:
an attachment layer configured to adsorb to a surface of a contact lens, the attachment layer and the contact lens being comprised of the same material; and
an image layer having an ornamental design and connected to one side of the attachment layer, the attachment layer being disposed between the contact lens and the image layer,
wherein the ornamental design of the image layer is disposed at a position corresponding to an iris of a user when the user wears the contact lens.

2. The color image patch of claim 1, further comprising:
a protection layer, and
wherein the image layer is disposed between the attachment layer and the protection layer.

3. The color image patch of claim 1, wherein the attachment layer is adsorbed to the surface of the contact lens through intermolecular force acting between the attachment layer and the contact lens, and
the intermolecular force is a chemical bond or a physical bond.

4. The color image patch of claim 3, wherein the chemical bond is at least one of a metallic bonding, an ionic bonding and a covalent bonding.

5. The color image patch of claim 3, wherein the physical bond is at least one of a hydrogen bond and a Van Der Waals bond.

6. The color image patch of claim 1, wherein the attachment layer includes a first opening,
the image layer includes a second opening,
the first opening and the second opening define a through hole of the color image patch, and
the through hole is disposed at a position corresponding to a pupil of the user when the color image patch is adsorbed to the contact lens.

7. (canceled)

8. The color image patch of claim 1, wherein the first material is a hydrophilic material.

9. The color image patch of claim 1, wherein the attachment layer is directly connected to the surface of the contact lens, and
the surface of the contact lens is a concave surface of the contact lens.

10. The color image patch of claim 1, wherein the protection layer comprises at least one of a resin, a cross-linking agent, an initiator, a solvent and an additive.

11. The color image patch of claim 2, wherein the attachment layer includes a first opening,
the image layer includes a second opening,
the protection layer includes a third opening,
the first opening, the second opening, and the third opening define a through hole of the color image patch, and
the through hole is disposed at a position corresponding to a pupil of the user when the color image patch is adsorbed to the contact lens.

12. The color image patch of claim 1, wherein the attachment layer is configured to detach from the surface of the contact lens.
